(19) United States
(12) Patent Application Publication
(10) Pub. No.: US 2015/0007567 A1
(43) Pub. Date: Jan. 8, 2015

(54) PLANT AND METHOD FOR INCREASING THE EFFICIENCY OF ELECTRIC ENERGY PRODUCTION

(71) Applicants: Piero Manzoni, Giussago (IT); Di Persico Lorenzo, Sesto San Giovanni (IT); Michele Scapolo, Torviscosa (IT)

(72) Inventors: Piero Manzoni, Giussago (IT); Di Persico Lorenzo, Sesto San Giovanni (IT); Michele Scapolo, Torviscosa (IT)

(73) Assignee: Falck Renewables Spa, Milano (IT)

(21) Appl. No.: 14/379,096

(22) PCT Filed: Feb. 4, 2013
(86) PCT No.: PCT/IB2013/050928

§ 371 Date: Aug. 15, 2014

(30) Foreign Application Priority Data
Feb. 15, 2012 (IT) MI2012A000221

(51) Int. Cl. F01K 7/40; F22D 1/00; F03G 6/00; F22D 1/32

(52) U.S. Cl. CPC F01K 7/40; F22D 1/32; F22D 1/003; F03G 6/003
USPC 60/645; 122/412; 122/441; 60/641.8; 60/667; 60/676

(57) ABSTRACT

A plant (10, 110) for the production of electric energy comprises a fuel boiler (11) in which a fluid is heated in order to produce steam, a turbine (15) which is connected to an electric generator (16) and to which said steam is conveyed, and a condenser unit (19) which re-condenses the fluid output from the turbine so that it may be conveyed back to the steam generator. The return fluid along the path from the condenser unit (19) to the boiler passes through a preheating unit (22) which receives heat from the turbine steam bleed-offs (23) and from a thermodynamic solar field (25). By making suitable use of the heat produced by the solar field (25) and contained in the heat-carrier fluid which passes through it, it is possible to increase the overall efficiency of the plant (10, 110). Furthermore, advantageously, the heat-carrier fluid which passes through the thermodynamic solar field receives heat from the fuel boiler via a suitable exchanger (32) which allows an increase in the productivity of the solar field itself and, moreover, uses the residual heat of the main plant which otherwise would be lost.

The present invention relates to a plant and to a method for increasing the efficiency of electric energy generation by means of a steam turbine.

In particular, the plant is of the type with a steam generating boiler which is supplied with fuel material.

In the art, plants for the production of electric energy are known where a fluid (usually water) is superheated to the vapour state by means of a suitable combustion boiler so as to be able to operate with it a turbine connected to an electric alternator, or turbo-alternator. The fluid, once it has passed through the turbine, is condensed again and conveyed back to the boiler in order to repeat the cycle. This thus forms the so-called Rankine cycle.

Various systems have been proposed in order to increase the efficiency of the process. For example, so-called “regeneration” by means of steam bleeding is known, this consisting in extracting part of the energy from the turbine, using part of the heat of the fluid present inside the turbine in order to heat the fluid itself after recondensation, so as to increase the enthalpy of the fluid entering the boiler.

Basically, along the turbine there are one or more bleed-off points which extract some of the steam and convey it to heat exchangers which are arranged in the circuit downstream of the main condenser and which thus heat the fluid in the return circuit to the boiler. The bled steam is then mixed with the fluid output from the main condenser so as to keep the fluid circuit closed.

The regeneration increases the efficiency of the cycle, but extracts part of the energy from the turbine.

Moreover, the requirements of the actual plant are such that the steam must be used to supply also other internal and external user appliances. Therefore there may be a large number of “bleed-off points” corresponding to the number of user appliances inside or outside the plant and these users may be other machines or, in most cases, heat exchangers which are used to heat other fluids (air, exhaust fumes, oils, etc.) useful for operation of the plant with all its accessory parts.

In the art, thermodynamic solar concentration plants are known where superheating of the fluid for driving the turbine is obtained by means of suitable concentration of the solar rays. As is well known, these plants have the obvious limitation of the non-programmability of the primary energy source, namely the sun. In order to reduce the negative impact of the availability of sun, it has also been proposed combining with the thermodynamic solar plants an auxiliary boiler which uses a conventional fossil fuel (methane gas, oil) or a renewable alternative source (biomass and/or waste) and systems for storing the heat produced, in order to ensure continuous production of the plant.

In these known plants, the main source is therefore the solar source obtained by means of a thermodynamic solar concentration plant in combination with an ORC (Organic Rankine Cycle) for the production of electric energy, and the use of other fuels in the auxiliary boiler has the sole purpose of compensating for the absence of solar energy and ensuring the minimum production of electric energy and/or heat also in conditions where there is limited solar radiation.

These types of combined plants are therefore usually simply realized as a combination of a normal solar plant and a normal fuel plant, one operating instead of the other one depending on the solar radiation conditions.

The management of such plants is however complicated, in particular owing to the need to manage the storage of sufficient quantities of heat. Moreover, the efficiency of the plant is never satisfactory.

WO2011/057881 describes a combined plant which uses a steam generating boiler and a solar field for heating the fluid returning to the boiler. The efficiency of such a combined plant is, however, still not satisfactory. For example a loss of irradiation on the solar panel results in a deterioration in the efficiency of the plant and possible malfunctioning due to the drop in temperature of the fluid of the solar field.

Similar combined plants with similar problems are also described in US2009/125152 and in “VERBESSERUNG FOSSILGEFEUERTER DAMPFKRAFTWERKE DURCH SOLARE WAERMEZUFUHR”, Marko A, BWK Brennstoff Warme Kraft, Springer VDI Verlag, Dusseldorf, DE—Vol.47,

The general object of the present invention is to provide a method and a plant for the production of electric energy based mainly on a steam turbine with heating of the fluid by means of a combustion boiler, but with the efficiency of the improved cycle due to the use of a suitable solar installation. In particular, the boiler may burn advantageously biomass or waste in order to reduce the environmental impact in terms of energy resources.

In view of this object the idea which has occurred according to the invention is to provide a plant for the production of electric energy comprising a fuel boiler, in which a fluid is heated to produce steam, a turbine which is connected to an electric generator and to which said steam is conveyed, a condenser unit which re-condenses the fluid output from the turbine so that it may be conveyed back to the boiler, thus forming a closed circuit, the return fluid along the path from the condenser unit to the boiler receiving heat from a preheating unit designed to receive heat both from turbine steam bleed-offs and from a heat-carrier fluid of a thermodynamic solar field. Advantageously, the plant comprises a circuit in which the heat-carrier fluid of the solar field may receive residual heat from the fumes emitted from the boiler.

Still according to the invention, the idea is to provide a method for the production of electric energy by means of a steam turbine in a plant comprising a fuel boiler in which a fluid is heated to produce steam, a turbine which is connected to an electric generator and to which said steam is conveyed, a condenser which re-condenses the fluid output from the turbine so that it may be conveyed back to the boiler, thus forming a closed circuit, wherein the return fluid between turbine and boiler is heated by means of a controlled combination of heat exchanges using steam bled from the turbine and fluid heated by a solar field, so as to employ, at least partially instead of the bleed-offs, the heat which is produced by the solar field when it is sufficiently irradiated. Advantageously, the heat-carrier fluid of the solar field is in turn heated, at least when the solar field is irradiated with an irradiation value less than a predetermined amount and/or when the temperature of the heat-carrier fluid falls below a predefined value, by means of the residual heat in the combustion fumes output from the boiler, so as to maintain at least a given minimum temperature value of this heat-carrier fluid of the solar field. A greater efficiency in the production of electric energy may thus be achieved

In order to illustrate more clearly the innovative principles of the present invention and its advantages compared to the prior art, examples of embodiment applying these principles will be described below, with the aid of the accompanying drawings. In the drawings:

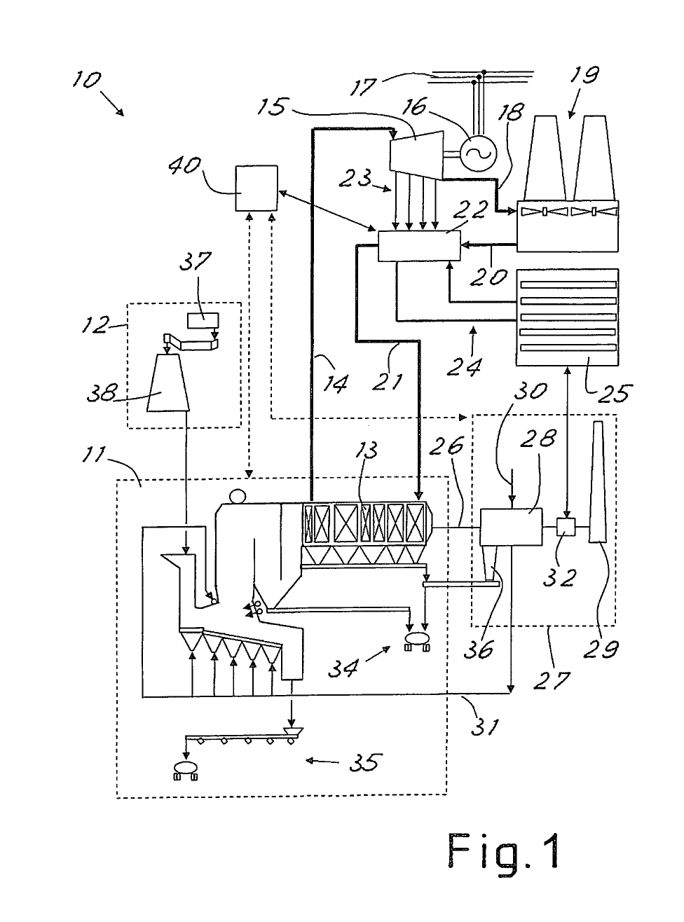

FIG. 1 shows a schematic view of a first plant for generating electric energy designed according to the invention;

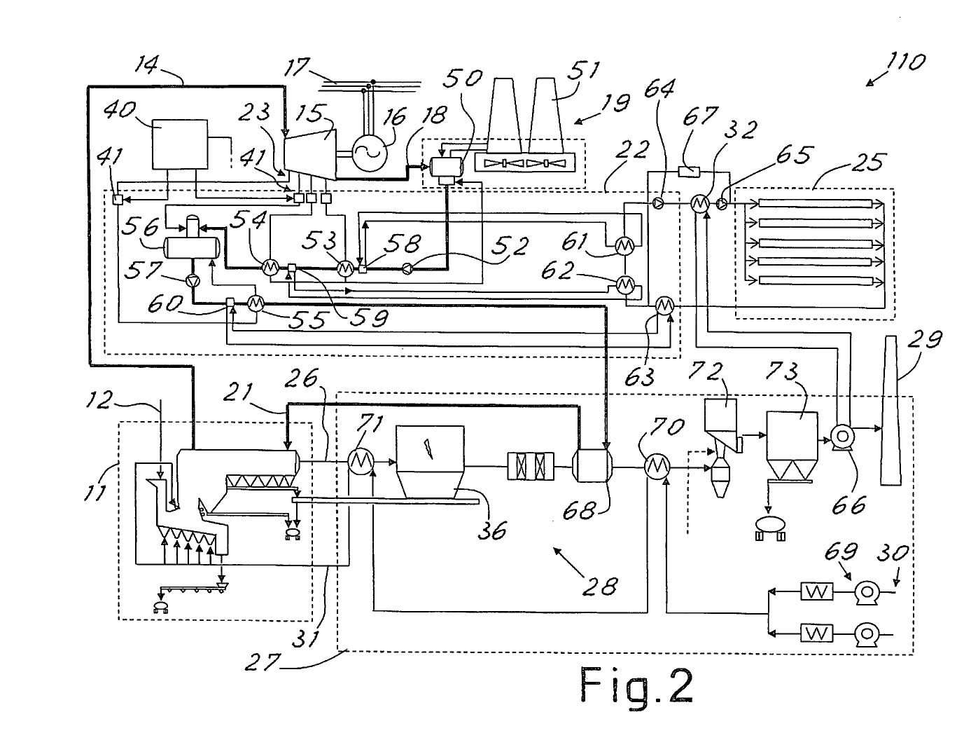

FIG. 2 shows a schematic view of a second embodiment of a plant according to the invention.

With reference to the figures, FIG. 1 shows a plant for the production of electric energy—denoted generally by 10—designed in accordance with the invention.

This plant 10 comprises a combustion unit or boiler 11 for the production of steam by means of combustion of a suitable fuel supplied by a source 12. The combustion heats a suitable fluid to the vapour state by means of suitable exchanger 13. The carrier fluid is advantageously water.

Advantageously, the fuel may be biomass.

In the case of a boiler which bums solid products, such as conventional biomass from vegetable waste, the boiler may comprise known systems 34, 35 (for example discharge systems with conveyor belts for performing conveying to storage and removal zones) for evacuation of the ashes. These systems may also receive the ashes and the solid pollutants recovered from the unit 28 and discharged at 36.

Especially in the case of biomass, the fuel source 12 may advantageously comprise a silo 38 for storing the fuel and, if required, also a silo with feet 37 for supplying it.

In particular, the extruded biomass generally reaches the plant already in the form of small-size pieces or intact and is stored for a short period of time inside the silo 37. If necessary, the size of the fuel is then further reduced using known means. The biomass is then moved and transported, for example using conveyor belts and/or feeder screws and/or bucket elevators, to the silo 38 which acts as a reservoir for loading the furnace.

Using pneumatic or mechanical systems, such as pistons or feeder screws (not shown since forming part of the known art which may be easily imagined by the person skilled in the art), the biomass is loaded into the furnace where it is burnt with the supply of the hot comburent air introduced into one or more sections of the combustion chamber.

The furnace may be of the known type provided with a self-powered grille or a fluid bed which ensure, in most of the applications, optimum mixing between fuel and combustion agent and also facilitate discharging of the residual ash resulting from combustion, conveying it towards the appropriate discharge hoppers.

In the case of fuel formed by urban waste, in general it may be more advantageous to store it in a very large ditch, instead of in a silo, from where the waste may be removed and loaded into the furnace for burning.

The combustion unit comprises a combustion furnace which produces hot fumes (for example at a temperature of about 800 to 1000° C.) which pass through the exchanger 13 (steam generator).

The steam output from the exchanger 13 is conveyed, via a line 14, to a turbine 15 which operates an electric generator 16 so as to power an electric line 17. From the turbine outlet 18 the fluid is conveyed into a suitable condenser unit 19, at the outlet 20 of which the condenser fluid is conveyed back to the exchanger 13 via a return line 21, so as to close the cycle.

The condenser unit 19 may be, for example, of the known water type, in particular with evaporation towers, or of the air type.

A preheating unit 22 is provided between the outlet 20 of the condenser 19 and the return line 21 connected to the boiler exchanger and heats the return fluid by means of a suitable series of bleed-offs 23 (for example four bleed-offs).

The preheating unit 22 also has, connected thereto, a fluid circuit 24 which is heated by means of a solar field 25 (namely an array of known devices for the production of fluid heated by solar radiation), advantageously of the concentration type with dimensions suitable for producing an adequate amount of heat, as will be clarified below.

The solar field is not further described nor shown in detail since it may be easily imagined by the person skilled in the art in the light of the explanation provided here. Generally said solar field may comprise flat or suitably shaped minors, the direction of which may be adjusted if necessary in order to achieve greater efficiency of the technology used and by means of which the sunlight is reflected and concentrated onto one or more tubes inside which a heat-carrier fluid (for example, water, diathermic oil, sodium and potassium salts, etc) flows. The tubing concentrates the energy which is transmitted to the heat-carrier fluid which is heated and conveys the heat to the user appliance (optionally via a suitable exchanger for transfer of the heat to another carrier fluid).

The hot fumes emitted from the boiler where combustion is performed are advantageously treated (for example with urea and lime) in order to reduce the concentration of pollutants and are dedusted (by means of electric filters and/or bag filters) before and/or after the section containing the exchanger 13 inside which the fumes/water heat exchange is concentrated.

In particular, the combustion fumes are output at 26 from the boiler and pass through a fumes treatment unit 27 which comprises a known unit 28 for eliminating the pollutants before the fumes are discharged via a chimney 29. The unit 28 may also advantageously comprise a system 30 which preheats the air which is drawn in from the outside and conveyed to the boiler, via the lines 31, in order to take part in the combustion process.

Again advantageously, the fumes, before reaching the chimney 29, may also pass through a further exchanger 29 for helping heat the fluid of the solar field 25, for the reasons which will be clarified below.

The plant 10 also envisages a control system 40 which manages the various operating parameters. This control system is advantageously designed with a suitably programmed microprocessor or wired-logic electronic system and receives information from suitable sensors (for example temperature sensors, pressure sensors, etc.) in order to control by means of suitable actuators (for example electric valves, electric motors, etc.) the various parts of the plant. Such a control system is known per se in the prior art and may be easily imagined by the person skilled in the art in the light of the description of the plant and its operation provided here. This control system will therefore not be described nor illustrated in detail.

In particular, according to one of the aspects of the invention, the control system also manages operation of the preheating unit 22, controlling (as will become clear below) heating, by means of the bleed-offs 23 and the solar field 25, of the fluid returning to the boiler, so as to use, wherever possible, the solar field entirely or partially in place of the bleed-offs. This has been found to increase significantly the average efficiency of the plant compared to a conventional plant, since when the solar field is irradiated it results in a significant increase in the enthalpy of the fluid directed to the boiler, while limiting or even eliminating altogether removal of energy from the turbine via the bleed-offs.

The control system, however, modifies the amount bled from the bleed-offs of the turbine depending on the production of hot fluid by the solar field, so as to keep the operating parameters of the preheating unit within predetermined efficiency parameters of the cycle, using the bleed-offs as little as possible.

For example, the control system may operate so as to maintain in the preheating unit predefined temperature gradients owing to the heat supplied by the bleed-offs and/or the carrier fluid supplied by the solar field, with a preference for using the heat produced by the solar field.

By means of a suitable design of the solar field (as may now be easily imagined by the person skilled in the art), in conditions where there is a maximum solar radiation, the heating achieved by the solar field may be sufficient to optimise the Rankine cycle without any need to use the heat from the bleed-offs, which may thus be completely closed.

Moreover, as will become clearer below, the bleed-offs used for production of the heat required by the auxiliary systems of the plant may also be replaced or supplemented by the solar heating circuit.

The solar field 25 therefore acts as an important backup for the plant which produces electric energy by means of the combustion boiler, but is not directly used to produce electric energy, but only to produce auxiliary heat for the main cycle.

However, owing to the principles of the invention, there exists a synergic transmission of heat between the two systems which may be advantageously also two-way, but with a dependency relation which is not binding as regards the continuous production of electric energy.

On the one hand, the heat produced by the solar field is used to increase the regeneration efficiency in the Rankine cycle of the main system employing a fuel boiler; on the other hand, the residual heat in the combustion fumes (which in a normal combustion plant would be lost with evacuation of the fumes since of poor quality) may be advantageously recovered by means of the exchanger 32 and may contribute towards heating the carrier fluid of the solar field (especially in conditions where there is little or no irradiation, for example at night time, when the temperature of the carrier fluid drops to a level below that of the fumes).

By using a quantity of residual heat of the fumes which otherwise would be lost, the recovered heat is converted into a electric energy with substantial benefits in terms of the overall efficiency of the combustion plant This contribution may increase especially during the transition hours between daytime and night-time.

The heat recovery also prolongs the daily operating time of the solar plant. In fact, when irradiation is present again, the greater initial temperature of the carrier fluid of the solar field shortens the activation times of the entire system, namely the time required to reach a temperature of the fluid heated by the solar field which allows satisfactory throttling of the bleed-offs in order to make use of the solar field for efficient heating of the return fluid from the turbine to the boiler. Similarly, when there is a decrease in the irradiation, the recovery of heat from the fumes delays lowering of the temperature of the carrier fluid of the solar field to below the minimum value needed to supply suitably regeneration and the other user appliances associated with the plant.

Owing to the principles of the invention, the increase in the time interval during which the solar system may be used for regeneration may be equivalent to about 1.5 hours (with reference to 8 hours per day). This therefore results in an increase of about 20% in the annual availability of the heat produced by the thermodynamic solar plant, without the need for storage systems which are generally required in conventional solar plants.

The combustion boiler acts as an accumulator for the thermodynamic solar plant, what is more without further consumption of resources or limitations for the solar plant. In fact, the combustion plant may receive all of the heat generated by the solar plant so to guarantee the stored energy to be used for prolonging operation thereof, without the need to limit it, as instead occurs in the existing conventional plants.

The primary circuit of the solar field also becomes a system for using the residual heat of the main cycle for generating power by means of the combustion boiler.

It can therefore be seen how the synergy between the two systems is effectively bidirectional. This synergy ensures a substantial increase in the overall efficiency of the combustion plant. This advantage, along with other advantages, will become even more evident below.

The preheating unit which uses the bleed-offs and the hot fluid of the solar field may obviously be designed in various ways, with several exchangers arranged in series or in parallel.

FIG. 2 shows an embodiment of a plant 110 according to the invention with a structure of the exchange unit which has been found to be particularly advantageous.

For the sake of simplicity, parts of the plant shown in FIG. 2 which are similar to those of the plant shown in FIG. 1 will be indicated by the same numbering used in FIG. 1.

The plant 110 therefore comprises the combustion heating unit 11, as already described above, which produces the steam (for example, at a temperature and pressure ranging between 400° C. and 40 bar and 500° C. and 65 bar) by means of combustion of a suitable fuel (advantageously biomass) supplied by the source 12.

The output circuit 14 conveys the steam produced by the combustion unit to the turbine 15 which operates the electric generator 16 for supplying the electric line 17. At the outlet 18 of the turbine the fluid is cooled owing to the condenser unit 19 and the condensed fluid is conveyed from the outlet 20 back to the exchanger 13 via the return line 21, so as to close the cycle after passing through the preheating unit 22 which is supplied with the carrier fluid heated by the solar field 25 and the bleed-offs 23.

Advantageously, in the embodiment shown in FIG. 2, the condenser unit 19 comprises a condenser 50 and cooling towers 51. The condenser 50 exchanges heat between the main fluid output from the turbine and a secondary fluid which is cooled in the towers 51.

The main fluid output from the condenser is conveyed (preferably by means of pump 52) through a suitable set of exchangers which form the preheating unit 22.

In the advantageous embodiment shown in FIG. 2 there are four steam bleed-offs 23 which are connected to respective first exchangers 53, 54, 55 which are passed through by the return fluid directed to the boiler.

Advantageously, the return fluid passes through a first low-pressure exchanger 53, a second low-pressure exchanger 54 and a third high-pressure exchanger 55, exchanging heat with the steam supplied by a bleed-off 23 which is respectively situated increasingly closer to the inlet of the turbine. Another bleed-off (advantageously at a midway point between the bleed-offs of the last and last but one exchanger) directly supplies a degasser 56 so as to keep it advantageously at a constant pressure and ensure a temperature of the fluid at the degasser outlet equal, for example, to about 120° C.

The temperature values will depend on the dimensions of the exchangers and the bleed-offs which are used. For example, in the case of water being used as the boiler fluid, it has been found advantageous if the steam bled from the turbine allows preheating of the return water with reference values for the ΔT of the exchangers 52, 53, 55 which range from 40° C. to 60° C. in the first exchanger, from 60° C. to 90° C. in the second exchanger and (after raising to 120° C. by means of the, degasser) from 120° C. to 190° C. in the third exchanger. An additional pump 57 for ensuring correct circulation of the fluid is preferably present between degasser 57 and exchanger 55.

Advantageously, the bled steam, after passing through the exchangers and releasing the heat to the return fluid, is introduced into the condenser 50, if output from the exchangers 53 and 54, and into the degasser 56, if output from the exchanger 55.

Respective branch-off points 58, 59, 60 which deviate the fluid flow also towards respective second exchangers or auxiliary exchangers 61, 62, 63 which exchange heat with the primary fluid flowing in the solar field are inserted in series with the first exchangers 53, 54, 55. For example, the dimensions of the solar field may be easily designed so that, when maximum irradiation is reached, the primary fluid is heated to a temperature of about 300° C.

As can be seen again in FIG. 2, the fluid returning to the boiler may also at the end pass through a low-temperature economizer 68 which makes use of the still relatively high temperature of the fumes emitted from the boiler.

Advantageously, the fluid for the boiler is water and the primary fluid of the solar field is diathermic oil. Therefore reference will be made below to these fluids, even though it is understood that other suitable fluids may be used depending on the specific requirements of the plant.

Since a temperature of not more than 400° C. is sufficient to perform heating of the process water, in the solar plant it is possible to use diathermic oil, which is undoubtedly preferably to the salts which are used in conventional high-temperature solar plants and which usually give rise to various operational problems (supply, storage and management thereof).

Obviously, as mentioned above it is also possible to use other carrier fluids, depending on the preferences, and the dimensions of the specific plant. Salts or water are therefore in any case not excluded, even though diathermic oil is a fluid of a suitable nature for this application and is preferred to salts and water.

For example, compared to water, the oil ensures a greater operational stability at the albeit relatively high temperatures (reference temperature 300° C.) and low pressures (reference pressure 10 bar) which are advantageously used in a plant according to the invention. With oil, therefore, the operational problems associated with the phase change conditions of the fluids, and the consequent plant control requirements, are eliminated.

Moreover, the demineralized water/diathermic oil exchangers are not critical components.

In the conditions of maximum irradiation of the solar field 25, the exchangers 61, 62, 63 will ensure for the fluid returning to the boiler the same temperature gradients produced by the bleed-offs, thus allowing the control system to close the turbine steam bleed-offs by means of suitable controlled valves 41, with a consequent increase in the amount of electrical energy produced for the same condition of the steam entering the turbine.

The second exchangers 61, 62, 63 are here advantageously designed to be arranged in series with the respective first exchangers 53, 54, 55 but could also be arranged in parallel, as can be easily imagined by the person skilled in the art, but this would result in the need for control of the flowrate of the water passing through them, depending on the temperature set downstream of the preheating unit.

With the arrangement in series, instead, adjustment of the temperature of the return fluid to the boiler may be concentrated also in the heat exchange in the first exchangers, by means of throttled opening of the bleed-offs depending on the temperature at the outlet of the corresponding second water/oil exchangers with respect to the desired set temperature.

Advantageously the control system 40 may be programmed to give precedence to the throttling of the bleed-offs with a higher energy value or, in the case considered here, starting from the bleed-off situated at the exchanger 55.

The flowrate of the main fluid of the solar field (advantageously diathermic oil) may be the sole variable depending on the irradiation.

Advantageously, the main fluid of the solar field (which is moved by suitable pumps 64, 65) also passes through the exchanger 32 (preferably owing to a circulation fan 66) such that a heat exchange occurs between this fluid and the fumes.

By making use of the residual heat of the fumes discharged from the chimney (which otherwise would be needlessly lost), this exchanger 32 allows the main fluid of the solar field, even in low or zero irradiation conditions, to be heated to a relatively high temperature (for example about 90° C., considering that on average the fumes output from the chimney in general have a temperature of about 130° C.). In this way it will be possible to heat the fluid returning to the boiler in the exchangers 61 and 62, also at night-time, when solar energy is not available.

Advantageously the exchanger 32 is preferably positioned to exchange heat with the fumes downstream of all the fume treatment and dedusting systems so as to reduce to a minimum the risk of acid condensates (tube corrosion) or blockage of the tube bundles (worsening of the hp). It is advisable in any case to provide an exchanger made of stainless steel or equivalent suitable material.

Moreover, a recirculation line 67 may be advantageously provided, said line also being managed by the control system 40 which at night time bypasses the solar field and conveys the primary fluid from of the solar field from the outlet of the exchanger 32 to the inlet of the exchangers 61, 62, avoiding heat dispersion in the solar field itself. The flow along the recirculation line will be advantageously suitably controlled by the control system 40 when the temperature of the fluid drops below the temperature for heating with the fumes owing to the lower irradiation.

Advantageously a station (known per se and therefore not shown in detail) may also be provided for reconveying the oil before and/or after the exchanger 32, with associated storage tank for regulating the load variations of the plant, so as to prevent needless head losses should the fluid not pass through the solar field.

By means of suitable controlled valves, advantageously all four exchangers 32, 61, 62, 63 may also be individually bypassed (both on the water side and on the oil side) under the control of the control system 40 in order to allow more flexible regulation. For example, advantageously the exchanger 63 may be bypassed when the temperature of the main fluid of the solar field falls below the temperature which is to be obtained as final temperature of the fluid returning to the boiler.

In fact, regulation of the combined assembly consisting of the solar system and the combustion system must ensure safe management of their interface, without inappropriate heat exchange between the systems. For example, should the combustion plant not be operative or be subject to a sudden shut-down, the main fluid of the solar plant must not exchange heat with water returning to the boiler since the working conditions of the latter would deviate from the design values (for example, with the risk of a dangerous water to steam phase changes). Not being able to regulate immediately the existing temperatures (slow cooling of the boiler) it is preferable to prevent heat exchange by means of closing/opening of suitable valves which suitably deviate the exchange fluids.

The heat of the fumes may also be advantageously used to heat the air to be sent to the boiler. For this purpose the air is drawn in by means of fans 69 and sent to exchangers 70, 71 in order to be heated by the flow of fumes directed from the boiler to the chimney.

The fumes treatment system may also comprise an electric filter 36, a lime reactor 72 and a bag filter 73 suitably arranged in series along the path of the fumes, using arrangements which are substantially known per se for eliminating the pollutants in the combustion fumes.

At this point it is clear how the predefined objects have been achieved, by proposing an innovative plant and an innovative method for increasing the efficiency of energy production by means of the combined assembly consisting of a thermodynamic solar plant and a plant with fuel boiler.

Owing to the synergy between the two systems used it is possible to compensate for the disadvantages of the single systems and improve the efficiency of the overall system. With this solution it is possible to use CSP (Concentrating Solar Power) technology solar plants with a low thermal potential (for example 1-10 MWt) in average-size combustion plants (for example 50 MWt) which have generation or cogeneration efficiency levels which are decidedly higher compared to the ORC cycles coupled directly with the solar field. It is possible consequently to make more efficient use of the heat generated using concentrating mirrors.

Moreover, the combustion boiler acts as heat storage unit for the thermodynamic solar plant, supplying heat to it in order to increase its production capacity. By eliminating the ORC cycle and also the storage systems which are normally present in the conventional configuration of solar concentration plants it is possible to obtain a simplification of the solar plant and a reduction in the overall plant dimensions.

By way of example of the greater efficiency which can be obtained with a plant according to the invention, we may consider an average-size plant burning wood biomass with a thermal potential of 50 MWt and electrical potential of 15 MWe and with a gross electrical efficiency of 30%, incorporating a thermodynamic solar plant with an available surface area of 30000 m² and a maximum thermal potential of the solar plant (irradiation=1000 Wh/m²) of 8 MWt.

In the case of maximum irradiation (≈1000 Wh/m²), for the same biomass consumption and steam production of the biomass plant, the energy supply of the concentration solar plant ensures an extra production of 1 MWe, due to the simultaneous closure of three turbine bleed-offs, and an increase in the performance of the biomass plant equivalent to two percentage points.

In fact, the greater production of electric energy which can be obtained using the heat supplied by the thermodynamic solar plant is equivalent to 1 MWe and this means that, if the maximum heat contribution available in the diathermic oil is taken as being 8 MWe, the conversion efficiency is equivalent to 12.5%.

A conventional ORC cycle thermodynamic solar plant with a 1.5 MWe turbine and aero-condenser instead has a nominal net efficiency of about 11%.

Comparing the two solutions it can be seen how there is a notable advantage (of about 10% in terms of electrical efficiency in the case considered) owing to the use of the Rankine cycle of the combustion plant in order to convert into electric energy the heat produced by the thermodynamic solar plant, for the same thermal potential of the latter.

Moreover, if a plant of the type described above is constructed in a geographical area with an annular irradiation equal for example to 1700 kWh/m² and this is compared with a conventional thermodynamic solar plant (with ORC and storage systems) of identical size and thermal potential, the annual production capacity for electric energy of the thermodynamic solar plant combined with the combustion plant, according to the invention, is equal to 3.5 Gwh/year, while the annual production capacity of a conventional thermodynamic solar plant would be equal to 2.5 Gwh/year.

By eliminating the ORC cycle and the storage systems and replacing them with a series of exchangers, which have a decidedly lower cost, it is possible to obtain a major reduction in both the investment costs (e.g. about 20% of the total costs) and the construction time compared to a conventional thermodynamic solar production system. Moreover, the management and maintenance costs are obviously lower, in view of the absence of major machinery (turbines, condensers, etc.) which otherwise would be needed.

Basically, with the plant described above according to the invention, there is a difference of 1000 MWh/year which results in an increase of at least 40% in the overall efficiency and a 20% reduction in the investment costs.

Remote control of the plant also results in a reduction in the number of operators on-site: in fact the same operators of the combustion plant may manage the solar plant as though it were an additional component of the combustion plant itself.

Moreover, owing to use of the solar plant to heat the return fluid of the combustion plant for the generation of electric power, and not for the direct generation of steam to be conveyed to the turbine, it is possible to work at temperatures lower than those required in conventional solar concentration plants for the production of electric energy.

Obviously, the above description of embodiments which apply the innovative principles of the present invention is provided by way of example of these innovative principles and must therefore not be regarded as limiting the scope of the rights claimed herein.

For example, the exact form, size, number of fluid flow paths or the construction materials may be chosen at the design stage depending on the temperatures and, in particular, the pressures involved, as may be easily imagined by the person skilled in the art.

Moreover, in the description of the plant according to the invention provided above, it has been preferred to use the residual heat of the fumes to heat the main fluid of the solar field in low or zero irradiation conditions. An alternative solution may also be that of providing the furnace with a system for cooling the fuel handling components (for example the grilles) in which the heat-carrier fluid is the main fluid of the solar field.

More generally, each cooling section inside the plant could be used for the purpose of heating the main fluid of the solar field, also in an operating arrangement with a dual heat-carrier fluid using for example diathermic oil and in parallel, for example, air. This concept may also be extended further, to the point of considering condensing the turbine discharge steam in an oil or water and oil condenser. All these variants may, in any case, now be easily imagined by the person skilled in the art owing to the description of the invention provided here and may be included within the scope of the invention, even though use of the fumes is preferred owing to the advantages of simplicity and efficiency involved.

It is understood that the minimum condition for the choice of the optimum point for performing exchange is usually determined by the ΔT between the sources (hot and cold), being by way of example preferably higher than 50° C.

In the case of stoppage of the combustion plant, the heat generated by the thermodynamic solar plant may also be used, with suitable arrangements which may be easily imagined by the person skilled in the art, in order to contribute towards cooling/heating of the premises.

1. Plant for the production of electric energy comprising a fuel boiler in which a fluid is heated in order to produce steam, a turbine which is connected to an electric generator and to which said steam is conveyed, a condenser unit which re-condenses the fluid output from the turbine so that it may be conveyed back to the boiler, thus forming a closed-circuit, the return fluid along the path from the condenser unit to the boiler receiving heat from a preheating unit designed to receive heat both from turbine steam bleed-offs and from a heat-carrier fluid of a thermodynamic solar field, characterized in that it comprises a circuit in which the heat-carrier fluid of the solar field may receive residual heat from the fumes emitted by the boiler.

2. Plant according to claim 1, characterized in that the preheating unit for receiving heat comprises first exchangers for heat exchange between the return fluid and the steam bleed-offs and second exchangers for heat exchange between the return fluid and the solar field.

3. Plant according to claim 2, characterized in that the first and second exchangers are arranged in series with each other.

4. Plant according to claim 1, characterized in that it comprises valves for controlling the bleed-offs and a system for controlling the plant which is connected to said valves so as to control reduction in the amount bled from the turbine steam bleed-offs when there is an increase in heating of the fluid by means of heat exchange with the solar field.

5. Plant according to claim 2, characterised in that the solar field has a primary heat-carrier fluid circuit which passes through said second exchangers, there being provided along the circuit a further exchanger for heating this primary heat-carrier fluid by means of heat exchange with the combustion fumes emitted by the boiler.

6. Plant according to claim 5, characterized in that a line is provided for controlled recirculation of the said primary heat-carrier fluid in order to exclude, upon operation, the flow of said fluid through the solar field.

7. Plant according to claim 2, characterized in that the first exchangers comprise a first low-pressure exchanger, a second low-pressure exchanger and a third high-pressure exchanger, each exchanger performing heat exchange with a bleed-off situated increasingly closer to the turbine inlet.

8. Plant according to claim 7, characterized in that the steam bled from the turbine and passing into the first and second exchangers is introduced into the condenser.

9. Plant according to claim 7, characterized in that a further bleed-off point supplies a degasser arranged between the second and third exchangers.

10. Plant according to claim 9, characterized in that the steam bled from the turbine and passing into the third exchanger is introduced into the degasser.

11. Plant according to claim 1, characterized in that the boiler comprises a furnace for combustion of biomass in order to heat, by means of the fumes produced, the fluid to be conveyed to the turbine.

12. Method for the production of electric energy by means of a steam turbine in a plant comprising a fuel boiler in which a fluid is heated to produce steam, a turbine which is connected to an electric generator and to which said steam is conveyed, a condenser which re-condenses the fluid output from the turbine so that it may be conveyed back to the boiler, thus forming a closed circuit, wherein the return fluid between turbine and boiler is heated by means of a controlled combination of heat exchanges using steam bled from the turbine and heat-carrier fluid heated by a solar field, such that the heat produced by the solar field, when the solar field is sufficiently irradiated, may replace at least partially the heat produced by the bled steam and such that the heat-carrier fluid of the solar field is in turn heated, at least when the solar field is irradiated by an irradiation value less than a predetermined amount and/or when the temperature of the heat-carrier fluid falls below a predefined value, by means of the residual heat in the combustion fumes output from the boiler, so as to maintain at least a given minimum temperature value of said heat-carrier fluid of the solar field.
